(19) United States
(12) Patent Application Publication
(10) Pub. No.: US 2023/0179693 A1
(43) Pub. Date: Jun. 8, 2023

(54) FULL-SCREEN DISPLAY DEVICE

(71) Applicant: WUHAN CHINA STAR OPTOELECTRONICS SEMICONDUCTOR DISPLAY TECHNOLOGY CO., LTD., Wuhan (CN)

(72) Inventor: Jun CHEN, Wuhan (CN)

(73) Assignee: WUHAN CHINA STAR OPTOELECTRONICS SEMICONDUCTOR DISPLAY TECHNOLOGY CO., LTD., Wuhan (CN)

(21) Appl. No.: 16/965,622

(22) PCT Filed: Jan. 8, 2020
(86) PCT No.: PCT/CN2020/070837

§ 371 Date: Jul. 29, 2020

(30) Foreign Application Priority Data
Sep. 25, 2019 (CN) 201910911429.9

(51) Int. Cl. H04M 1/02

(52) U.S. Cl. CPC H04M 1/0264; H04M 1/0266; H04M 1/0274; H04M 1/0277; H04M 2250/52

(57) ABSTRACT

A full-screen display device includes a display screen and a main board module. The display is disposed directly facing the main board module. The main board module includes a camera, a flexible circuit board, and a first connector. One end of the flexible circuit board is electrically connected to the camera, another end is connected to the main board module through the first connector. The flexible circuit board is provided with a passing hole directly facing the camera, so that the camera is closely attached to the display and is not shielded by the flexible circuit board.

This application claims the priority of China Patent Application serial No. 201910911429.9, filed Sep. 25, 2019, titled “FULL-SCREEN DISPLAY DEVICE”, the disclosures of which are incorporated herein by reference in their entirety.

### BACKGROUND OF INVENTION

### 1. Field of Invention

The present invention relates to a technical field of displays, and particularly to, a full-screen display device.

### 2. Related Art

With ever-changing display technologies and increasing demand of the public, high screen-ratio is becoming an unstoppable trend. Compared with current mobile devices, high screen ratio mobile devices have narrower bezels and wider display areas and also have smaller dimensions in comparison with current mobile devices having a same screen size. However, because front panels of mobile devices are provided with some essential components, such as cameras and infrared sensors, certain spaces are needed in most of displays of current mobile devices for accommodating relevant components. One method of providing such spaces is to make holes directly on displays, which affects a high screen ratio of the displays to a certain extent. Another method is to dispose components such as cameras in the displays through sliding structures or ejecting mechanisms, but in this manner, thickness and weight of display devices are increased, as well as structural complexity.

Therefore, there are still problems with current full-screen display devices, such as a high screen-ratio of displays adversely affected by positions of cameras of full-screen display devices and increases in thickness, weight, and structural complexity of display devices, which need to be overcome urgently.

### SUMMARY OF INVENTION

The present application provides a full-screen display device to overcome problems of the prior art that a high screen-ratio of displays adversely affected by positions of cameras of full-screen display devices, and increases in thickness, weight, and structural complexity of display devices.

In order to overcome the above-mentioned problems, the present application provides a technical solution as follows:

The present application provides a full-screen display device, comprising a display screen and a main board module; wherein the display screen is disposed directly facing the main board module and is rectangular in shape, and the main board module comprises a camera, a flexible circuit board, and a first connector; wherein one end of the flexible circuit board is electrically connected to the camera, another end is connected to the main board module through the first connector, and the flexible circuit board is provided with a passing hole directly facing the camera, so that the camera is closely attached to the display screen and is not shielded by the flexible circuit board.

In one embodiment of the present invention, the camera and the flexible circuit board are connected through a second connector.

In one embodiment of the present invention, the camera and the flexible circuit board are connected by soldering.

In one embodiment of the present invention, the camera and the flexible circuit board are connected by surface mount technology.

In one embodiment of the present invention, the passing hole has a size greater than that of the camera.

In one embodiment of the present invention, the passing hole is circular, rectangular, triangular, or oval in shape.

In one embodiment of the present invention, the passing hole is a semi-closed hole.

In one embodiment of the present invention, the camera is circular, rectangular, triangular, or oval in shape.

In one embodiment of the present invention, the display screen comprises signal lines electrically connected with a second connector, a soldering place, or a surface mount place through the first connector.

In one embodiment of the present invention, the camera comprises an optical lens, a photosensitive chip, a main control chip, and a base.

Compared with the prior art, the full-screen display device of the present application has advantageous effects as follows:

1. first: based on the full-screen display device of the present application, a camera is disposed under a display screen, so neither a hole needs to be formed on the display screen, nor a sliding or an ejecting mechanism is provided for disposing of the camera, thereby not only increasing a screen ratio of the display screen, but also simplifying complexity of the display device, truly achieving high screen ration displaying;

2. secondly: a flexible circuit board and the camera are connected by a second connector, soldering, or surface mount technology, which is convenient to detect the camera when installing, saving room for installation, and enables more stable signal transmission; and

3. finally, the camera of the full-screen display device includes an optical lens, a photosensitive chip, a main control chip, and a base, wherein the photosensitive chip can achieve analog to digital conversion, the main control chip can also perform artificial intelligence processing on image signal information, such as beautifying or increasing an amount of light to improve beauty and sharpness of a photo.

### BRIEF DESCRIPTION OF DRAWINGS

To describe the technical solutions in the embodiments of the present invention, the following briefly introduces the accompanying drawings for describing the embodiments. Apparently, the accompanying drawings in the following description show merely some embodiments of the present invention, and a person skilled in the art may still derive other drawings from these accompanying drawings without creative efforts.

FIG. 1 is a first schematic structural view of a full-screen display device in accordance with an embodiment of the present application.

FIG. 2 is a second schematic structural view of a full-screen display device in accordance with an embodiment of the present application.

FIG. 3 is a flowchart showing a method of controlling a camera of a full-screen display device in accordance with an embodiment of the present application.

### DESCRIPTION OF PREFERRED EMBODIMENTS

The technical solutions in the embodiments of the present application will be clearly and completely described in the following with reference to the accompanying drawings in the embodiments. Apparently, the embodiments as described are only a part, but not all, of the embodiments of the present application. Based on the embodiments in the present application, all other embodiments obtained by those skilled in the art without creative efforts shall be within the scope of the present application.

In the description of the present application, it is to be understood “that the term “center”, “longitudinal”, “lateral”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise” and the like indicates orientation or the orientation or positional relationship based on the positional relationship shown in the drawings, for convenience of description only and the present application is to simplify the description, but does not indicate or imply that the device or element referred to must have a particular orientation in a particular orientation construction and operation, and therefore not be construed as limiting the present application. In addition, the terms “first” and “second” and the like are used for descriptive purposes only and are not to be construed as indicating or implying relative importance. Thus, features defining “first” or “second” may include one or more of the described features either explicitly or implicitly. In the description of the present invention, the meaning of “a plurality” is two or more unless specifically and specifically defined otherwise.

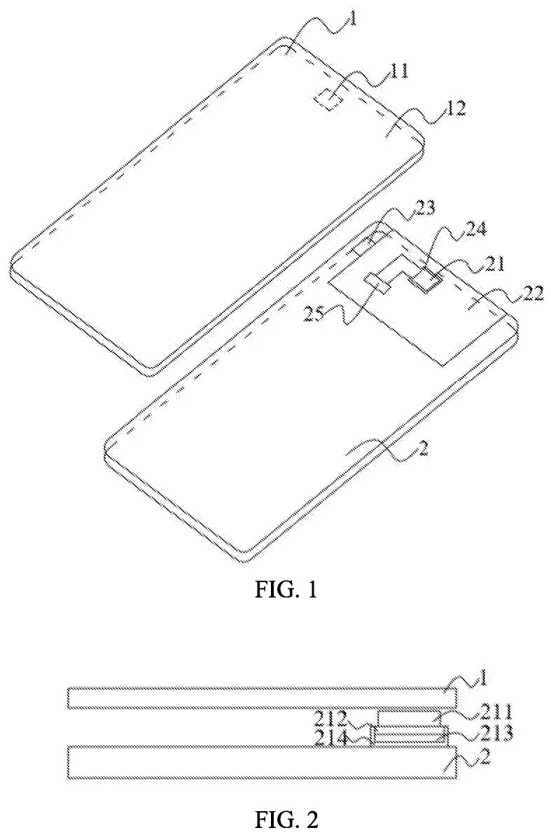

The present application provides a full-screen display device. Please refer to FIGS. 1 to 3 for specific structures.

The present application is to achieve an authentic full-screen display to increase a high screen-ration without adding additional mechanical structures, such as sliding structures or ejecting mechanisms, which give rise to an increase in thickness, weight, and structural complexity of a display device. The present application is to dispose a camera on a main board module under a display screen to achieve an under-screen camera structure neither occupying a display area of the display screen nor adding any extra mechanical structure. Additionally, there are three different connecting manners provided to connect the camera and a flexible circuit board. In this manner, during production processes of the full-screen display device, it is convenient to detect installation of the camera and save space, making signal transmission more stable and reducing product cost.

Please refer to FIG. 1 showing a first schematic structural view of a full-screen display device in accordance with an embodiment of the present application. The present application provides a display screen 1 and a main board module 2. The display screen 1 is rectangular in shape and is disposed directly facing and above the main board module 2. The main board module 2 includes a camera 21, a flexible circuit board 22, and a first connector 23. One end of the flexible circuit board 22 is electrically connected to the camera 21, and another end is connected to the main board module 2 through the first connector 23. Furthermore, the flexible circuit board 22 is provided with a passing hole 24 directly facing the camera 21, so that the camera 21 is closely attached to the display screen 1 and is not shielded by the flexible circuit board 22.

In one embodiment of the present application, the camera 21 and the flexible circuit board 22 are connected through a second connector 25 to enable a simple and convenient assembly. In another embodiment of the present application, the camera 21 and the flexible circuit board 22 are connected by soldering, for which a manufacturing cost is the lowest. In another embodiment of the present application, the camera 21 and the flexible circuit board 22 are connected by surface mount technology (SMT) without being transferred through an extra component, so that room for connection can be saved and signal transmission is faster and more stable.

In another embodiment of the present application, the second connector, a soldering place, or a surface mount place and signal lines of the display screen 1 are electrically connected to the main board module 2 through the first connector 23.

In another embodiment of the present application, the passing hole 24 has a size greater than that of the camera 21 so that the entire camera 21 can be exposed to the flexible circuit board 22. The passing hole 24 may be circular, rectangular, triangular, or oval in shape, but is not limited thereto. A shape of the passing hole 24 should be configured as a regular shape as possible to reduce area of the flexible circuit board 22. At the same time, the passing hole 24 is a semi-closed hole, that is, part of the passing hole 24 is formed with a cutout for providing a place for lines or connectors and the like.

In one embodiment of the present application, the camera 21 may be circular, rectangular, triangular, or oval in shape, but is not limited thereto. Also, a shape of the camera 21 is preferably a regular shape. Furthermore, a shape of the passing hole 24 should be corresponding to that of the camera 21, but the passing hole 24 has a hole diameter slightly greater than that of the camera 21 for certain reasons, wherein one reason is that the entire camera 21 can be exposed to the passing hole 24, a second reason is that room for installing the camera can be saved, and a third reason is to reduce manufacturing cost.

In one embodiment of the present application as shown in FIG. 2, the camera 21 includes an optical lens 211, a photosensitive chip 212, a main control chip 213, and a base 214. The optical lens 211 is configured to obtain external light and is disposed directly facing a first display region 11 of the display screen 1, wherein a second display region 12 is defined on areas of the display screen 1 other than the first display region 11. When the camera 21 is operating, the first display region 11 receives light, so that external light signals enter the camera 21. When the camera 21 is not operating, the first display region 11 and the second display region 12 cooperatively work to display screen images. The first display region 11 has a shape corresponding to a projection of the optical lens 211 projected to the display screen 1, and the first display region 11 has an area the same as an area of the projection of the optical lens 211 on the display screen 1, wherein the area of the first display region 11 is less than that of the second display region 12. The photosensitive chip 212 is configured to convert captured image information into digital image signal information, that is, to realize conversion of an optical image signal into a digital image signal. The main control chip 213 then processes the obtained image signal information with artificial intelligence (AI), so on one hand, when using the camera 21 to take photos, the photos can be made more beautiful. Besides, an AI mode can also be turned off optionally when the camera 21 is in use, that is, the camera is in an original picture mode. Therefore, the main control chip 213 here can also provide a function as a mode selection function, and users can select the original picture mode or the artificial intelligence processing mode according to actual needs. On the other hand, when ambient light is dark, the main control chip 213 can also be adjusted, which is equivalent to turning on an auxiliary flash function to increase an amount of light entering the camera 21 and to make the photos sharper. The photosensitive chip 212, the main control chip 213, and the optical lens 211 are all disposed on the base 214. A main objective of the base 214 is to fix the photosensitive chip 212, the main control chip 213, and the optical lens 211.

In one embodiment of the present application, the display screen 1 and the main board module 2 are rectangular in shape, and the full-screen display device may be a mobile phone, a tablet computer, an electronic watch, etc.

In one embodiment of the present application, a working principle of the camera 21 is as follows: when external objects are projected to the photosensitive chip through an optical image generated by the optical lens of the camera 21, the photosensitive chip 212 converts external light signals into electrical signals to achieve analog to digital (A/D) data conversion into digital image signal. The photosensitive chip 212 transmits electrical signals to the main control chip 213 through internal transmission. The main control chip 213 processes digital signals, and then transmits the signals to the display screen 1 through signal lines of the display screen 1 from a connection between the camera 21 and the flexible circuit board 22 to the first connector 23, so that an image can be displayed on the display screen 1.

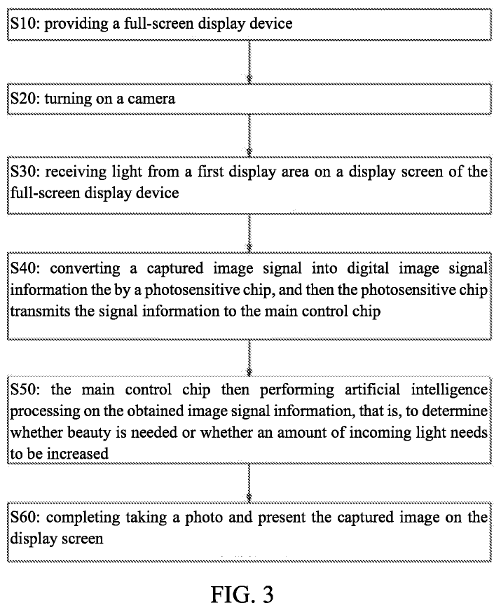

Please refer to FIG. 3. The present application further provides a method of controlling a camera of a full-screen display device. The full-screen display device for the controlling method includes all characteristics of the full-screen display device in the aforementioned embodiments. The method includes specific steps as follows: S10: providing a full-screen display device; S20: turning on a camera; S30: receiving light from a first display area on a display screen of the full-screen display device; S40: converting a captured image signal into digital image signal information the by a photosensitive chip, and then the photosensitive chip transmits the signal information to the main control chip; S50: the main control chip then performing artificial intelligence processing on the obtained image signal information, that is, to determine whether beauty is needed or whether an amount of incoming light needs to be increased; and S60: completing taking a photo and present the captured image on the display screen.

Therefore, the full-screen display device provided by the present application has advantageous effects as follows: first: based on the full-screen display device of the present application, a camera is disposed under a display screen, so neither a hole needs to be formed on the display screen, nor a sliding or an ejecting mechanism is provided for disposing of the camera, thereby not only increasing a screen ratio of the display screen, but also simplifying complexity of the display device, truly achieving high screen ration displaying; secondly: a flexible circuit board and the camera are connected by a second connector, soldering, or surface mount technology, which is convenient to detect the camera when installing, saving room for installation, and enables more stable signal transmission; finally, the camera of the full-screen display device includes an optical lens, a photosensitive chip, a main control chip, and a base, wherein the photosensitive chip can achieve analog to digital conversion, the main control chip can also perform artificial intelligence processing on image signal information, such as beautifying or increasing an amount of light to improve beauty and sharpness of a photo.

The full-screen display device provided by the embodiments of the present invention is described in detail above. Specific examples are used herein to explain the principle and implementation of this application. The descriptions of the above embodiments are only used to help understand the technical solution of this application and its core ideas. Those skilled in the art should understand that they can still modify the technical solutions described in the foregoing embodiments, or replace some of the technical features equivalent. These modifications or replacements do not make the essence of the corresponding technical solutions outside the scope of the technical solutions of the embodiments of the present application.

What is claimed is:

1. A full-screen display device, comprising:
a display screen and a main board module;
wherein the display screen is disposed directly facing the main board module and is rectangular in shape, and the main board module comprises a camera, a flexible circuit board, and a first connector;
wherein one end of the flexible circuit board is electrically connected to the camera, another end is connected to the main board module through the first connector, and the flexible circuit board is provided with a passing hole directly facing the camera, so that the camera is closely attached to the display screen and is not shielded by the flexible circuit board.

2. The full-screen display device of claim 1, wherein the camera and the flexible circuit board are connected through a second connector.

3. The full-screen display device of claim 1, wherein the camera and the flexible circuit board are connected by soldering.

4. The full-screen display device of claim 1, wherein the camera and the flexible circuit board are connected by surface mount technology.

5. The full-screen display device of claim 1, wherein the passing hole has a size greater than that of the camera.

6. The full-screen display device of claim 5, wherein the passing hole is circular, rectangular, triangular, or oval in shape.

7. The full-screen display device of claim 6, wherein the passing hole is a semi-closed hole.

8. The full-screen display device of claim 5, wherein the camera is circular, rectangular, triangular, or oval in shape.

9. The full-screen display device of claim 1, wherein the display screen comprises signal lines electrically connected with a second connector, a soldering place, or a surface mount place through the first connector.

10. The full-screen display device of claim 1, where the camera comprises an optical lens, a photosensitive chip, a main control chip, and a base.

11. A full-screen display device, comprising:
a display screen and a main board module;
wherein the display screen is disposed directly facing the main board module, and the main board module comprises a camera, a flexible circuit board, and a first connector;
wherein one end of the flexible circuit board is electrically connected to the camera, another end is connected to the main board module through the first connector, and the flexible circuit board is provided with a passing hole directly facing the camera, so that the camera is closely attached to the display screen and is not shielded by the flexible circuit board.

12. The full-screen display device of claim 11, wherein the camera and the flexible circuit board are connected through a second connector.

13. The full-screen display device of claim 11, wherein the camera and the flexible circuit board are connected by soldering.

14. The full-screen display device of claim 11, wherein the camera and the flexible circuit board are connected by surface mount technology.

15. The full-screen display device of claim 11, wherein the passing hole has a size greater than that of the camera.

16. The full-screen display device of claim 15, wherein the passing hole is circular, rectangular, triangular, or oval in shape.

17. The full-screen display device of claim 16, wherein the passing hole is a semi-closed hole.

18. The full-screen display device of claim 15, wherein the camera is circular, rectangular, triangular, or oval in shape.

19. The full-screen display device of claim 11, wherein the display screen comprises signal lines electrically connected with a second connector, a soldering place, or a surface mount place through the first connector.

20. The full-screen display device of claim 11, where the camera comprises an optical lens, a photosensitive chip, a main control chip, and a base.
